(19) United States
(12) Patent Application Publication
(10) Pub. No.: US 2013/0334958 A1
(43) Pub. Date: Dec. 19, 2013

(54) PLANAR LIGHT EMITTING DEVICE AND MANUFACTURING METHOD THEREOF

(71) Applicants: Motonobu Aoki, Osaka (JP); Shingo Houzumi, Osaka (JP)

(72) Inventors: Motonobu Aoki, Osaka (JP); Shingo Houzumi, Osaka (JP)

(73) Assignee: PANASONIC CORPORATION, Osaka (JP)

(21) Appl. No.: 14/002,868

(22) PCT Filed: Mar. 6, 2012
(86) PCT No.: PCT/JP2012/055705

§ 371 Date: Sep. 3, 2013

(30) Foreign Application Priority Data
Mar. 7, 2011 (JP) 2011-049360

(51) Int. Cl. H05B 33/04

(52) U.S. Cl. CPC H05B 33/04
USPC 313/504; 445/23

(57) ABSTRACT

A planar light emitting device includes an element substrate, a cover substrate of a rectangular plate shape, and a bonding section. The element substrate includes an optically-transparent substrate of a rectangular plate shape, and an organic EL element formed on one surface side of the optically-transparent substrate. The bonding section is formed in a rectangular frame shape surrounding a light emitting section of the organic EL element on the one surface side of the optically-transparent substrate, and is made of an adhesive that bonds the element substrate to the cover substrate. The bonding section has a wide section in a portion along a non-cut surface, which is not a cut surface, of four side surfaces of the optically-transparent substrate. The wide section is wider than the other portions.

### TECHNICAL FIELD

The present invention relates to a planar light emitting device and a manufacturing method of the planar light emitting device.

### BACKGROUND ART

Conventionally, an organic electroluminescence (EL) device 101 having a configuration shown in FIG. 11 and FIG. 12 is disclosed (Patent literature 1). This organic EL device 101 is a color organic EL device of an active matrix type, and is an organic EL panel where one pixel region 110 is constituted by three sub pixel regions 110A, 110B, and 110C for outputting respective color lights of R (red), G (green), and B (blue). In the organic EL device 101, an image display region A0 is formed of pixel regions 110 arranged like a matrix.

The organic EL device 101 includes an element substrate 111 substantially rectangular in the plan view, a sealing substrate 112, an adhesive 113 for bonding the element substrate 111 and sealing substrate 112 together, and a filler 114 disposed in a region between the element substrate 111 and sealing substrate 112 and is surrounded with the adhesive 113.

The element substrate 111 includes a substrate body 121 made of an optically-transparent material such as glass, an element forming layer 122 stacked on the substrate body 121, an anode layer 123, a light emitting layer 124, a cathode layer 125, and a cathode protective film 126. In the element substrate 111, an organic EL element 127 is constituted by the anode layer 123, the light emitting layer 124, and the cathode layer 25.

The anode layer 123 is made of an optically-transparent electrically-conductive material such as ITO (indium tin oxide). The light emitting layer 124 is made of a kind of various light emitting materials such as phosphorescent materials and fluorescent materials, for example, a low-molecular organic light-emission pigment or a polymeric emitter. The light emitting layer 124 is formed to emit light of a white color in response to voltage application. The cathode layer 125 has a structure where a lithium fluoride film and an aluminum film are sequentially stacked from the light emitting layer 124 side.

The sealing substrate 112 includes a substrate body 131, and a color filter layer 132 and a light shielding layer 133 that are formed on the surface of the substrate body 131 that faces the element substrate 111.

The color filter layer 132 is made of acrylic, for example, and contains color materials corresponding to respective display colors of sub pixel regions 110A, 110B, and 1100.

The adhesive 113 is made of an ultraviolet curable resin, for example, and has a substantially rectangular shape that surrounds the outer periphery of the image display region A0 in a loop state. The adhesive 113 includes first to fourth portions 141 to 144 that are continuously and sequentially formed counterclockwise from the starting point 113A of application of the adhesive 113 toward the finishing point 113B.

The first portion 141 is extended from the starting point 113A substantially in the long-axis direction of the image display region A0. The starting point 113A as the base end of the first portion 141 is enlarged in a substantially elliptical shape. A starting end 141A including the starting point 113A in the first portion 141 is tilted with respect to the long-axis direction of the image display region A0 so that the starting end 141A separates from the image display region A0 as it extends from the starting point 113A toward the front end. The first portion 141 is extended from the tip of the starting end 141A in the long-axis direction of the image display region A0.

The second portion 142 is extended from the tip of the first portion 141 in the short-axis direction of the image display region A0.

The third portion 143 is extended from the tip of the second portion 142 in the long-axis direction of the image display region A0.

The fourth portion 144 is extended from the tip of the third portion 143 in the short-axis direction of the image display region A0. A finishing end 144A as the tip of the fourth portion 144 is folded to the long-axis direction of the image display region A0. The finishing end 144A is tilted with respect to the long-axis direction of the image display region A0 so that the finishing end 144A extends from an edge of the element substrate 111 to the proximity of the image display region A0, namely to the finishing point 113B. Then, the finishing point 113B as the tip of the finishing end 144A is enlarged in a substantially elliptical shape.

Here, the edges of the starting point 113A and the finishing point 113B are connected to each other. Thus, the adhesive 113 surrounds the outer periphery of the image display region A0 in a loop state.

The filler 114 has a gas barrier property for preventing the moisture or oxide of the external air from arriving at the organic EL element 127.

A manufacturing method of the organic EL device 101 disclosed by Patent literature 1 is hereinafter described.

First, the element substrate 111 is manufactured. In this process, the element forming layer 122 is formed on the substrate body 121, and then the anode layer 123, the light emitting layer 124, and the cathode layer 125 are formed on the element forming layer 122. Then, the cathode protective film 126 is formed on the cathode layer 125. Here, on the element substrate 111, a scheduled region A1 (see FIG. 13) is formed using a plurality of organic EL elements 127 arranged in a plane shape. The scheduled region A1 becomes the image display region A0 when the organic EL device 101 is manufactured.

The sealing substrate 112 is manufactured by forming the color filter layer 132 and the light shielding layer 133 on the substrate body 131.

Subsequently, an applying process of applying the adhesive 113 is performed. In this process, the adhesive 113 is applied so as to surround the outer periphery of the scheduled region A1 using an applying device such as a dispenser.

Specifically, as shown in FIG. 13, the starting point 113A is disposed outside the scheduled region A1 having a rectangular shape in the plan view and near a first corner of the scheduled region A1. Then, the starting end 141A is formed in a tilted state with respect to the long-axis direction of the scheduled region A1 by application of the adhesive 113 so that the adhesive 113 separates from the scheduled region A1 as it counterclockwise extends from the starting point 113A. Furthermore, the first portion 141 is formed by applying the adhesive 113 in the long-axis direction of the scheduled region A1 from the tip of the starting end 141A to a proximity of a second corner of the scheduled region. Here, the starting point 113A is disposed at a position separated from the image display region A0 so that the adhesive 113 at the starting point 113A does not arrive at the image display region A0 when the adhesive 113 becomes flat in a pasting process discussed later.

Next, the second portion 142 is formed by applying the adhesive 113 in the short-axis direction of the scheduled region A1 from the proximity of the second corner to the proximity of a third corner. The third portion 143 is formed by applying the adhesive 113 in the long-axis direction of the scheduled region A1 from the proximity of the third corner to the proximity of a fourth corner.

Then, the adhesive 113 is applied in the short-axis direction of the scheduled region A1 from the proximity of the fourth corner to the proximity of the first corner. Furthermore, the finishing end 144A is formed by applying the adhesive 113 so that the adhesive 113 is folded near the first corner to the first portion 141. Here, the adhesive 113 is tilted with respect to the long-axis direction of the scheduled region A1 so that the adhesive 113 approaches the scheduled region A1 as it extends to the first portion 141. Thus, the fourth portion 144 is formed. At this time, the fourth portion 144 is applied so that it does not cross the first portion 141. The finishing point 113B is separated from the starting point 113A and is positioned farther from the scheduled region A1 than the starting point 113A. Here, the starting point 113A is separated from the finishing point 113B by such a distance that the adhesive 113 at the starting point 113A comes into contact with the adhesive 113 at the finishing point 113B in the pasting process discussed later.

Thus, the adhesive 113 is applied in a substantially rectangular shape so as to surround the outer periphery of the scheduled region A1 counterclockwise from the starting point 113A to the finishing point 113B.

Then, the filler 114 is applied to the region which is inside of the applied adhesive 113 and which is on the element substrate 111. Here, the adhesive 113 is applied in the applying process so that the starting end 141A of the first portion 141 is close to the fourth portion 144 near the first corner of the scheduled region A1 and the finishing end 144A of the fourth portion 144 is folded toward the first portion 141.

Subsequently, the pasting process of pasting the element substrate 111 to the sealing substrate 112 is performed. In this process, ultraviolet rays are emitted to the applied adhesive 113 to increase the viscosity of the adhesive 113, and the element substrate 111 is pasted to the sealing substrate 112 via the adhesive 113 and the filler 114 through vacuum pressing. At this time, the amount of the adhesive 113 applied at each of the starting point 113A and finishing point 113B is more than that of the adhesive 113 applied at the other positions. Therefore, the adhesives 113 at the starting point 113A and the finishing point 113B are connected to each other when they become flat during the pasting. Thus, a closed space is formed which is confined by the element substrate 111, sealing substrate 112, and adhesive 113, and therefore the filler 114 does not leak to the outside. Here, the adhesive 113 at each of the starting point 113A and the finishing point 113B becomes flat, but it is so adjusted that the adhesive 113 at each of the starting point 113A and finishing point 113B does not spread farther from the scheduled region A1 than the adhesive 113 at the other part does.

Next, a scribing process of forming a scribe line 151 (see FIG. 13) in the pasted element substrate 111 and the sealing substrate 112 is performed. In this process, the scribe line 151 is formed so as to surround the outer periphery of the adhesive 113. Then, the element substrate 111 and the sealing substrate 112 are cut along the scribe line 151.

### CITATION LIST

### Patent Literature

Patent literature 1: JP-A No. 2010-272273

### SUMMARY OF INVENTION

### Technical Problem

The inventors of the application intend to use an organic EL element as a light source for illumination, and consider whether or not the above-mentioned manufacturing method of the organic EL device 101 can be employed as the manufacturing method of a planar light emitting device using the organic EL element.

In the manufacturing method of the organic EL device 101, however, the adhesive 113 at the starting point 113A is separate from the adhesive 113 at the finishing point 113B at the time when the adhesive 113 is applied in the applying process. Therefore, there is a concern that the adhesive 113 at the starting point 113A may not be connected to the adhesive 113 at the finishing point 113B in the pasting process, and the reliability can be reduced.

In the manufacturing method of the organic EL device 101, a dispenser is used in the applying process, and respective application amounts at the starting point 113A and the finishing point 113B are apt to vary. Therefore, the application amounts at the starting point 113A and the finishing point 113B are required to be larger than those at the other part so that the starting point 113A is connected to the finishing point 113B in the pasting process. The width of the adhesive 113 thus increases in the pasting process, and hence the width from the scheduled region A1 in the element substrate 111 to a scribe line 151 increases. Therefore, in the element substrate including an organic EL element on one surface side of the optically-transparent substrate in the planar light emitting device, decrease in distance between the light emitting section of the organic EL element and a cut end of the optically-transparent substrate is restricted by the width of the wide part of the adhesive, and accordingly the area of a no-light-emitting section increases.

The present invention addresses the above-mentioned problems. The present invention provides a planar light emitting device allowing decrease in area of the no-light-emitting section and improvement in reliability, and a manufacturing method of the planar light emitting device.

### Solution to Problem

A planar light emitting device of the present invention includes the following elements: an element substrate including an optically-transparent substrate of a rectangular plate shape and an organic EL element formed on one surface side of the optically-transparent substrate; a cover substrate of a rectangular plate shape; and a bonding section that is formed in a rectangular frame shape that surrounds a light emitting section of the organic EL element on the one surface side of the optically-transparent substrate and is made of an adhesive that bonds the element substrate to the cover substrate. The bonding section has a wide section in a portion along a non-cut surface, which is not a cut surface, of four side surfaces of the optically-transparent substrate. The wide section is wider than the other portions.

In the planar light emitting device, the organic EL element preferably includes the following elements: a first electrode that is disposed on the one surface side of the optically-transparent substrate and formed of a transparent electrically conductive film; an organic EL layer that is disposed on the surface of the first electrode on the opposite side to the optically-transparent substrate and includes at least a light emitting layer; a second electrode that is disposed on the surface of the organic EL layer on the opposite side to the first electrode, and is formed of a metal film; a first terminal electrically connected to the first electrode; a second terminal electrically connected to the second electrode; and an auxiliary electrode that is made of a material of a specific resistance lower than that of the first electrode, is formed along the periphery of the surface of the first electrode on the opposite side to the optically-transparent substrate, and is electrically connected to the first electrode. In the element substrate, preferably, the first terminal and the second terminal are disposed at each of both ends of a defined direction on the one surface side of the optically-transparent substrate. Preferably, the wide section is formed at a position where the direction orthogonal to the defined direction corresponds to the width direction.

In the planar light emitting device, preferably, each of the first terminal and the second terminal has a laminated structure of a transparent conducting oxide layer and a metal layer. Preferably, only the transparent conducting oxide layer is in contact with the bonding section.

The manufacturing method of the planar light emitting device of the present invention includes the following processes: an applying process of applying an adhesive to a first substrate that has a rectangular plate shape allowing the element substrates to be arranged in a 2×i (“i” is an integer of 1 or more) array and is divided into individual element substrates, or a second substrate that has a rectangular plate shape allowing the cover substrates to be arranged in a 2×j (“j” is equal to “i”) array and is divided into individual cover substrates; an overlaying process of overlaying the second substrate on the first substrate; a curing process of forming the bonding section by curing the adhesive; and a dividing process in which the first substrate is divided into individual element substrates and the second substrate is divided into individual cover substrates. In the applying process, a starting point of application and a finishing point of application when the adhesive is applied in the rectangular frame shape by the dispenser are set in a scheduled region for forming the wide section.

### Advantageous Effects of Invention

The planar light emitting device of the present invention allows decrease in area of the no-light-emitting section and improvement in reliability.

### BRIEF DESCRIPTION OF DRAWINGS

FIG. 1 is a rear view of a planar light emitting device of an embodiment;

FIG. 2 shows the planar light emitting device of the embodiment, FIG. 2(a) is a schematic sectional view taken in the line B-B′ of FIG. 1, FIG. 2(b) is a schematic sectional view taken in the line C-C′ of FIG. 1, and FIG. 2(c) is a schematic sectional view taken in the line G-G′ of FIG. 1;

FIG. 3 shows the planar light emitting device of the embodiment, FIG. 3(a) is a schematic sectional view taken in the line D-D′ of FIG. 1, FIG. 3(b) is a schematic sectional view taken in the line E-E′ of FIG. 1, and FIG. 3(c) is a schematic sectional view taken in the line F-F′ of FIG. 1;

FIG. 4 is a plan view of an essential process for illustrating a manufacturing method of the planar light emitting device of the embodiment;

FIG. 5 is a plan view of another essential process for illustrating the manufacturing method of the planar light emitting device of the embodiment;

FIG. 6 is a plan view of yet another essential process for illustrating the manufacturing method of the planar light emitting device of the embodiment;

FIG. 7 is a plan view of still another essential process for illustrating the manufacturing method of the planar light emitting device of the embodiment;

FIG. 8 is a plan view of still another essential process for illustrating the manufacturing method of the planar light emitting device of the embodiment;

FIG. 9 is a plan view of still another essential process for illustrating the manufacturing method of the planar light emitting device of the embodiment;

FIG. 10 is a plan view of still another essential process for illustrating the manufacturing method of the planar light emitting device of the embodiment;

FIG. 11 is a plan view showing a conventional organic EL device;

FIG. 12 is a schematic sectional view showing the organic EL device of FIG. 11; and

FIG. 13 is a plan view showing an applying process of an adhesive in the organic EL device of FIG. 11.

### DESCRIPTION OF EMBODIMENTS

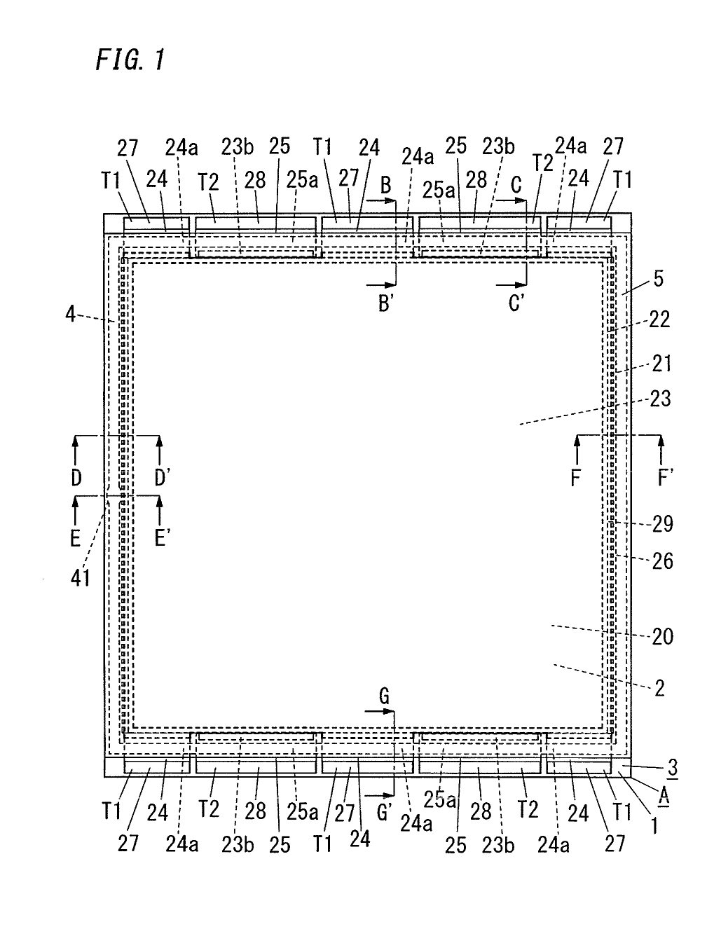

A planar light emitting device of the present embodiment is described hereinafter based on FIG. 1 to FIG. 3.

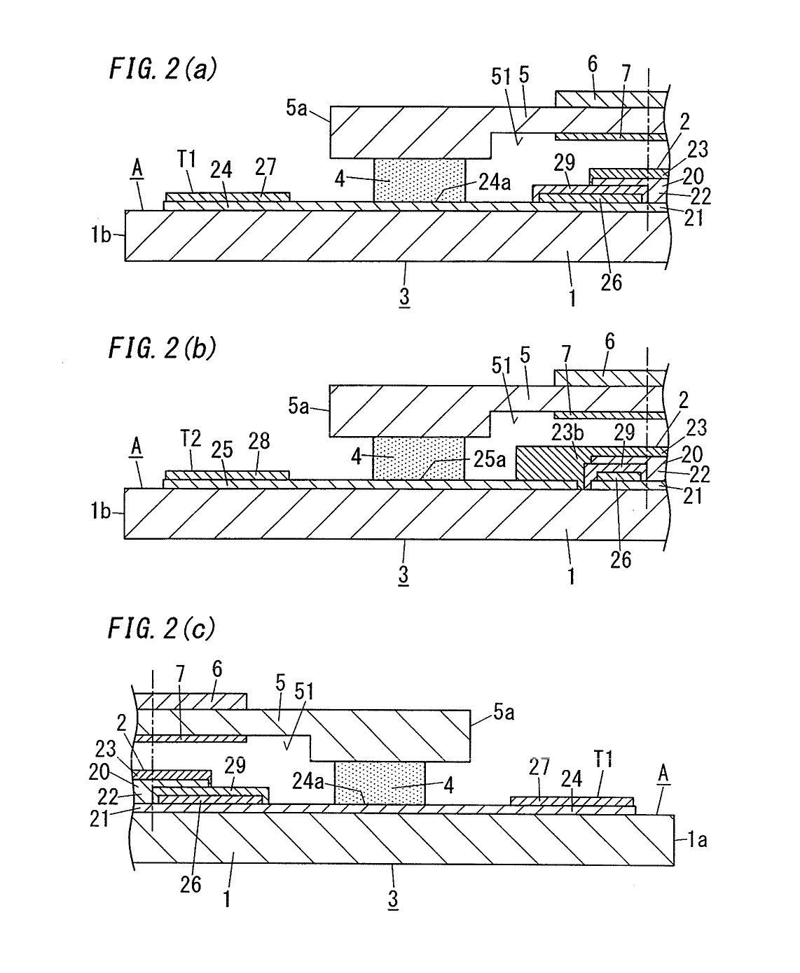

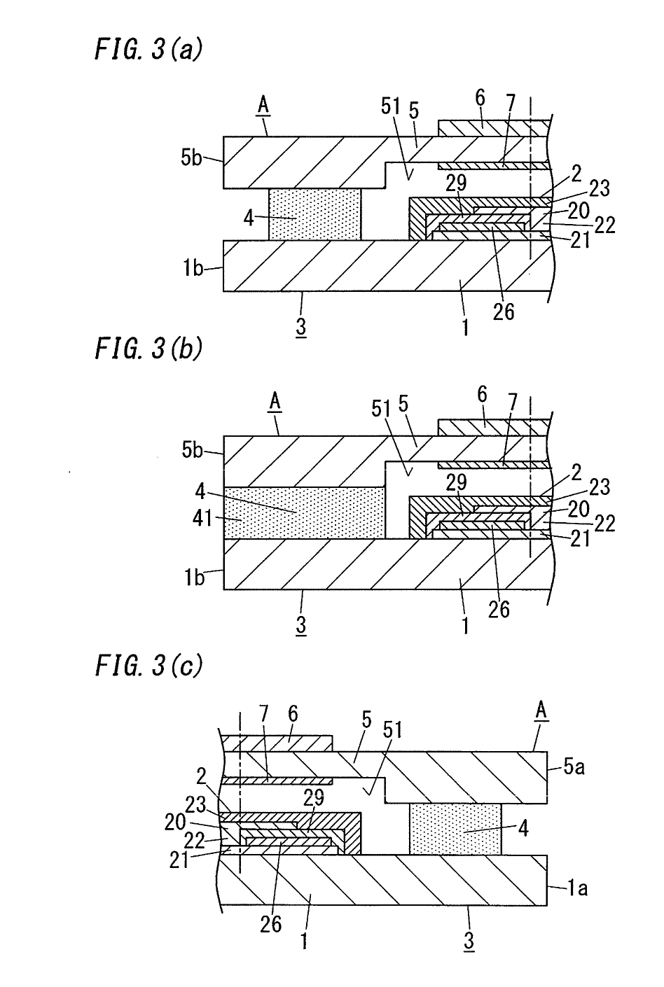

The planar light emitting device A includes: an element substrate (organic EL element module) 3 including an optically-transparent substrate 1 and an organic EL element 2 formed on one surface side of the optically-transparent substrate 1; and a cover substrate 5 that is disposed so as to face the one surface side of the optically-transparent substrate 1 and is bonded to the element substrate 3 via a bonding section 4. The planar light emitting device A also includes a heat equalization plate 6 (see FIG. 2 and FIG. 3) disposed on the surface of the cover substrate 5 on the opposite side to the organic EL element 2. The cover substrate 5 includes a recess 51 in its surface facing the element substrate 3, and the whole periphery of the recess 51 in the facing surface is bonded to the element substrate 3. Thus, in the planar light emitting device A, a light emitting section 20 of the organic EL element 2 is stored in an airtight space surrounded with the optically-transparent substrate 1, the cover substrate 5, and the bonding section 4. In the planar light emitting device A, a hygroscopic member 7 for absorbing moisture is pasted on the inner bottom surface of the recess 51 in the cover substrate 5.

The organic EL element 2 includes: a first electrode 21 that is disposed on the one surface side of the optically-transparent substrate 1 and formed of a transparent electrically conductive film; an organic EL layer 22 that is disposed on the surface of the first electrode 21 on the opposite side to the optically-transparent substrate 1 and includes a light emitting layer made of an organic material; and a second electrode 23 that is disposed on the surface of the organic EL layer 22 on the opposite side to the first electrode 21 and formed of a metal film.

The organic EL element 2 also includes: a first terminal T1 that is disposed in a lateral part to the light emitting section 20, in which the first electrode 21, the organic EL layer 22, and the second electrode 23 are overlaid on each other and that is electrically connected to the first electrode 21; and a second terminal T2 that is disposed in a lateral part to the light emitting section 20 and that is electrically connected to the second electrode 23. Here, the second electrode 23 is electrically connected to the second terminal T2 via a lead wire 23b extended from the second electrode 23.

The organic EL element 2 also includes an auxiliary electrode 26 that is made of a material of a specific resistance lower than that of the first electrode 21, is formed along the periphery of the surface of the first electrode 21 on the opposite side to the optically-transparent substrate 1, and is electrically connected to the first electrode 21. The organic EL element 2 also includes an insulating film 29 for covering the auxiliary electrode 26 and a side edge of first electrode 21 on the one surface side of the optically-transparent substrate 1. In the organic EL element 2, the insulating film 29 prevents a short circuit between the second electrode 23 and the auxiliary electrode 26 and between the second electrode 23 and the first electrode 21. The auxiliary electrode 26 is formed in a rectangular frame shape along the whole periphery of the surface of the first electrode 21 on the opposite side to the optically-transparent substrate 1. However, the shape of the auxiliary electrode 26 is not limited to the rectangular frame shape. The shape may be a partially open shape (e.g. C shape or U shape), or may be divided into a plurality of parts as long as the auxiliary electrode 26 is electrically connected to the first electrode 21.

In the organic EL element 2, the light emitting section 20 is constituted by a region in which the optically-transparent substrate 1, the first electrode 21, the light emitting layer, and the second electrode 23 overlap each other in the thickness direction of the optically-transparent substrate 1. The region other than the light emitting section 20 defines a no-light-emitting section. Here, in the organic EL element 2, the plan-view shape of each of the first electrode 21, the organic EL layer 22, and the second electrode 23 is set as a rectangular shape (square shape in the illustrated example) smaller than that of the optically-transparent substrate 1. Therefore, the plan-view shape of the light emitting section 20 is a rectangular shape (square shape in the illustrated example) smaller than that of the optically-transparent substrate 1. The plan-view shape of the auxiliary electrode 26 is set as a rectangular frame shape (square frame shape in the illustrated example). The plan-view shape of the insulating film 29 is set as a rectangular frame shape (square frame shape in the illustrated example).

In the organic EL element 2, m (m=2 in the example of FIG. 1) second terminals T2 and (m+1) (3 in the example of FIG. 1) first terminals T1 are disposed along each of two predetermined parallel sides of the rectangular light emitting section 20. Here, a first terminal T1 is disposed on each of the both sides of a second terminal T2 in the width direction. Therefore, in the example of FIG. 1, the optically-transparent substrate 1 is provided with the first terminals T1 and second terminals T2 on each of the both sides in the longitudinal direction thereof. Specifically, in the organic EL element 2, in each of the both ends of the optically-transparent substrate 1 in the longitudinal direction, three first terminals T1 are separately disposed in the lateral direction of the optically-transparent substrate 1, and a second terminal T2 is disposed between adjacent first terminals T1 in the lateral direction of the optically-transparent substrate 1. In the present embodiment, the longitudinal direction on the one surface of the optically-transparent substrate 1 is set as the defined direction, and the element substrate 3 includes first terminals T1 and second terminals T2 in each of the both ends of the defined direction on the one surface of the optically-transparent substrate 1.

Here, each first terminal T1 has a laminated structure of a transparent conducting oxide layer 24 (hereinafter referred to also as a first transparent conducting oxide layer 24) and a metal layer 27 (hereinafter referred to also as a first metal layer 27). Each second terminal T2 has a laminated structure of a transparent conducting oxide layer 25 (hereinafter referred to also as a second transparent conducting oxide layer 25) and a metal layer 28 (hereinafter referred to also as a second metal layer 28).

Here, the plane shape of the heat equalization plate 6 is set as a rectangular shape (square shape in the illustrated example) that is smaller than the cover substrate 5 and larger than the light emitting section 20.

Hereinafter, each component of the planar light emitting device A is described in detail.

In the planar light emitting device A, the other surface of the optically-transparent substrate 1 is used as a light outgoing surface (light emitting surface). Therefore, in the planar light emitting device A, in the other surface of the optically-transparent substrate 1, the region on which three components, namely the first electrode 21, the organic EL layer 22, and the second electrode 23 are overlaid constitutes the light emitting surface. The plan-view shape of the optically-transparent substrate 1 is set as an oblong shape. However, the present embodiment is not limited to this. The plan-view shape may be set as a square shape.

The optically-transparent substrate 1 is formed of a glass substrate, but the present embodiment is not limited to this. A plastic substrate may be used, for example. Examples of the glass substrate include a soda lime glass substrate and a non-alkali glass substrate. Examples of the plastic substrate include a polyethylene terephthalate (PET) substrate, a polyethylene naphthalate (PEN) substrate, a polyether sulfone (PES) substrate, and a polycarbonate (PC) substrate. When a plastic substrate is employed, an SiON film or an SiN film may be formed on a surface of the plastic substrate to suppress permeation of moisture.

When a glass substrate is employed as the optically-transparent substrate 1, irregularities of the one surface of the optically-transparent substrate 1 can cause a leak current of the organic EL element 2 (can cause degradation of the organic EL element 2). When a glass substrate is employed as the optically-transparent substrate 1, therefore, it is preferable to prepare a glass substrate for element formation that is accurately polished so as to reduce the roughness of the one surface. The roughness of the one surface of the optically-transparent substrate 1 is preferably set as follows: the arithmetic mean roughness Ra defined by JIS B 0601-2001 (ISO 4287-1997) is several nm or less. On the other hand, when a plastic substrate is employed as the optically-transparent substrate 1, an optically-transparent substrate where the arithmetic mean roughness Ra of the one surface is several nm or less can be obtained at low cost without especially requiring accurate polishing.

In the organic EL element 2, the first electrode 21 works as an anode and the second electrode 23 works as a cathode. In the organic EL element 2, the organic EL layer 22 interposed between the first electrode 21 and the second electrode 23 includes: a hole transport layer; the light emitting layer; an electron transport layer; and an electron injection layer, in this order from the first electrode 21 side.

The laminated structure of the organic EL element 22 is not limited to this example. For example, the following structures may be employed: a single layer structure of a light emitting layer; a laminated structure of a hole transport layer, a light emitting layer, and an electron transport layer; a laminated structure of a hole transport layer and a light emitting layer; and a laminated structure of a light emitting layer and an electron transport layer. A hole injection layer may be interposed between the first electrode 21 and the hole transport layer. The light emitting layer may have a single layer structure or a multilayer structure. For example, when a desired luminescent color is white, the following structures may be employed: a structure where the light emitting layer is doped with three kinds of dopant pigments of red, green, and blue; a laminated structure of a blue positive-hole transport light emitting layer, a green electron transport light emitting layer, and a red electron transport light emitting layer; and a laminated structure of a blue electron transport light emitting layer, a green electron transport light emitting layer, and a red electron transport light emitting layer. A multi-unit structure may be also employed, in which a plurality of light emitting units are stacked and electrically connected in series via intermediate layers having light transmission and electrical conductivity and are electrically directly interconnected, where each light emitting unit is constituted by an organic EL layer 22 and has a function of emitting light when it is disposed between a first electrode 21 and a second electrode 23 and is applied with a voltage by them. In other words, in the multi-unit structure, a plurality of light emitting units are overlaid in the thickness direction between one first electrode 21 and one second electrode 23.

The first electrode 21 constituting the anode is an electrode for injecting holes into the light emitting layer. Preferably, the first electrode 21 is made of an electrode material selected from a metal, an alloy, an electrically conductive compound, and a mixture thereof which have a large work function. Preferably, the electrode material having a work function of 4 eV or higher and 6 eV or lower is selected so as to prevent excessive increase of the difference between an energy level of the first electrode 21 and an HOMO (Highest Occupied Molecular Orbital) level. The electrode material of the first electrode 21 may be an electrically-conductive light-transmissive material selected from the following materials: ITO, tin oxide, zinc oxide, IZO (indium zinc oxide), and copper iodide; an electrically conductive polymer such as PEDOT or polyaniline; an electrically conductive polymer doped with any acceptor; and a carbon nanotube. In this case, the first electrode 21 is produced as a thin film on the one surface side of the optically-transparent substrate 1 by a sputtering method, a vacuum vapor deposition method, or an application method, for example.

Preferably, the sheet resistance of the first electrode 21 is several hundreds Ω/□ (ohm per square) or less, especially preferably 100Ω/□ or less. Depending on the light transmission and sheet resistance thereof, the thickness of the first electrode 21 is set at 500 nm or less, more preferably in a range of 10 nm to 200 nm.

The second electrode 23 constituting the cathode is an electrode for injecting electrons into the light emitting layer. Preferably, the second electrode 23 is made of an electrode material selected from a metal, an alloy, an electrically conductive compound, and a mixture thereof which have a small work function. Preferably, the electrode material having a work function of 1.9 eV or higher and 5 eV or lower is selected so as to prevent excessive increase of the difference between an energy level of the second electrode 23 and a LUMO (Lowest Unoccupied Molecular Orbital) level. The electrode material of the second electrode 23, for example, can be selected from aluminum, silver, magnesium, gold, copper, chromium, molybdenum, palladium, tin, and an alloy of these metals and the other metal. Specific examples of the alloy are a magnesium-silver mixture, a magnesium-indium mixture, and an aluminum-lithium alloy. The electrode material may also be a laminated film of an ultra-thin film that is made of a metal, a metal oxide, or a mixture of them and the other metal (such as aluminum oxide), and a thin film made of aluminum. Here, the ultra-thin film is a thin film with a thickness of 1 nm or less and can transmit electrons by tunnel injection. As the electrode material of the second electrode 23, preferably, a metal is employed where the reflectance of light emitted from the light emitting layer is high and the resistivity is low. Aluminum or silver is preferable.

As the material of the light emitting layer, any material known as a material for an organic EL element can be employed. Examples of the material, although not limited to them, include anthracene, naphthalene, pyrene, tetracene, coronene, perylene, phthaloperylene, naphthaloperylene, diphenylbutadiene, tetraphenylbutadiene, coumalin, oxadiazole, bisbenzoxazoline, bisstyryl, cyclopentadiene, a quinoline-metal complex, a tris(8-hydroxyquinolinate)aluminum complex, a tris(4-methyl-8-quinolinate)aluminum complex, a tris(5-phenyl-8-quinolinate)aluminum complex, an aminoquinoline-metal complex, a benzoquinoline-metal complex, a tri-(p-terphenyl-4-yl)amine, 1-aryl-2,5-di(2-thienyl)pyrrole derivative, pyrane, quinacridone, rubrene, a distyrylbenzene derivative, a distyrylarylene derivative, a distyrylamine derivative, and various phosphor pigments as well as the above-mentioned materials and their derivatives. An appropriate mixture of luminescent materials selected from these compounds is also preferably employed. In addition to a compound exemplified above that causes fluorescent emission, the following materials may be employed suitably: materials that cause light emission from spin-multiplets (for example, phosphorescent materials that cause fluorescent emission); and compounds that have a portion constituted by them in a part of a molecule. The light emitting layer made of these materials may be formed by a dry process such as a vapor deposition method or a transfer method. Alternatively, the light emitting layer may be formed by a wet process such as a spin coating method, a spray coating method, a die coating method, or a gravure printing method.

The hole injection layer may be made of a hole injection organic material, a hole injection metal oxide, an acceptor-type organic material or inorganic material, or a p-doped layer. An example of the hole injection organic material is a material that exhibits a hole transporting property, has a work function of about 5.0 eV to 6.0 eV, and exhibits a strong adhesiveness to the first electrode 21. For example, the material is CuPc or a starburst amine. The hole injection metal oxide is a metal oxide containing, for example, any one of molybdenum, rhenium, tungsten, vanadium, zinc, indium, tin, gallium, titanium, and aluminum. The hole injection metal oxide may be not only an oxide of one metal, but also an oxide of a combination of plurality of metals including at least one of above-mentioned metals, such as a combination of indium and tin, indium and zinc, aluminum and gallium, gallium and zinc, and titanium and niobium. The hole injection layer made of these materials may be formed by a dry process such as a vapor deposition method or a transfer method. Alternatively, the hole injection layer may be formed by a wet process such as a spin coating method, a spray coating method, a die coating method, or a gravure printing method.

The material of the hole transport layer can be selected from a group of compounds having hole transporting property, for example. Examples of such compounds include an aryl amine compound, an amine compound containing a carbazole group, and an amine compound containing a fluorene derivative. Typical examples of these compounds include 4,4′-bis[N-(naphthyl)-N-phenyl-amino]biphenyl (alpha-NPD), N,N′-bis(3-methylphenyl)-(1,1′-biphenyl)-4,4′-diamine (TPD), 2-TNATA, 4,4′,4″-tris(N-(3-methylphenyl)N-phenylamino)triphenylamine (MTDATA), 4,4′-N,N′-dicarbazolebiphenyl (CBP), spiro-NPD, spiro-TPD, spiro-TAD, and TNB. Note that, any generally-known hole transport material may be employed.

The material of the electron transport layer can be selected from compounds having electron transporting property. Examples of such compounds include a metal complex such as Alq₃ known as an electron transport material, and a heterocyclic compound such as a phenanthroline derivative, a pyridine derivative, a tetrazine derivative, and an oxadiazole derivative. The material of the electron transport layer is not limited to these compounds, and any generally-known electron transport material can be employed.

The material of the electron injection layer may be selected from the following compounds: a metal halide such as a metal fluorides (e.g. lithium fluoride or magnesium fluoride) or a metal chloride (e.g. sodium chloride or magnesium chloride); an oxide, nitride, carbide, or oxynitride of various metals such as aluminum, cobalt, zirconium, titanium, vanadium, niobium, chromium, tantalum, tungsten, manganese, molybdenum, ruthenium, iron, nickel, copper, gallium, zinc, and silicon (for example, aluminum oxide, magnesium oxide, iron oxide, aluminum nitride, silicon nitride, silicon carbide, or silicon oxynitride); an insulator such as boron nitride; a silicon compound such as SiO₂ or SiO; and a carbon compound. These materials can be formed in a thin film shape by a vacuum vapor deposition method or a spattering method.

The material of the lead wire 23b is the same as that of the second electrode 23. The thickness of the lead wire 23b is set the same as that of the second electrode 23. The lead wire 23b is formed continuously to the second electrode 23. In the planar light emitting device A of the present embodiment, the lead wire 23b and the second electrode 23 can be simultaneously formed during manufacturing. The lead wire 23b is extended onto a portion, which is a portion further inside of a region 25a through which the second transparent conducting oxide layer 25 is bonded to the bonding section 4, of the second terminal T2. The width (wire width) dimension of the lead wire 23b is set slightly smaller than that of the second terminal T2 so as to prevent short circuit to the first terminal T1 and keep a predetermined insulation distance from the first terminal T1. The width dimension of the lead wire 23b is preferably smaller than that of the second terminal T2, but preferably is as large as possible in order to increase the electro-migration resistance.

The material of each of the first transparent conducting oxide layer 24 and the second transparent conducting oxide layer 25 is a transparent conducting oxide (TCO) such as ITO, AZO, GZO, or IZO. The materials of the first transparent conducting oxide layer 24 and the second transparent conducting oxide layer 25 are set the same as the material of the first electrode 21, and the thicknesses of the first electrode 21, the first transparent conducting oxide layer 24, and the second transparent conducting oxide layer 25 are set equal to each other.

Preferably, the material of each of the first metal layer 27 and the second metal layer 28 is a metal such as aluminum, silver, gold, copper, chromium, molybdenum, aluminum, palladium, tin, lead, or magnesium, or an alloy containing at least one of these metals. The first metal layer 27 and the second metal layer 28 may have a multilayer structure instead of a single layer structure. The first metal layer 27 and the second metal layer 28 may have a three-layer structure of MoNb layer/AlNd layer/MoNb layer, for example. In this three-layer structure, preferably, the lower MoNb layer is used as an adhesion layer to the base, and the upper MoNb layer is used as a protective layer of the AlNd layer. In the present embodiment, the materials of the first metal layer 27 and the second metal layer 28 are set the same, and the thicknesses of the first metal layer 27 and the second metal layer 28 are set equal to each other. The materials of the first metal layer 27 and the second metal layer 28 may have the same as the material of the second electrode 23.

Preferably, the material of the auxiliary electrode 26 is a metal such as aluminum, silver, gold, copper, chromium, molybdenum, aluminum, palladium, tin, lead, or magnesium, or an alloy containing at least one of these metals. The auxiliary electrode 26 may have a multilayer structure instead of a single layer structure. The auxiliary electrode 26 may have a three-layer structure of MoNb layer/AlNd layer/MoNb layer, for example. In this three-layer structure, preferably, the lower MoNb layer is used as an adhesion layer to the base, and the upper MoNb layer is used as a protective layer of the AlNd layer. In the planar light emitting device A of the present embodiment, the material of the auxiliary electrode 26 is set the same as the materials of the first metal layer 27 and second metal layer 28. Thus, in manufacturing the planar light emitting device A of the present embodiment, the auxiliary electrode 26, the first metal layer 27, and the second metal layer 28 can be simultaneously formed, and accordingly the cost can be reduced.

As the material of the insulating film 29, polyimide is employed, for example. However, instead of it, novolac resin or epoxy resin may be employed, for example.

In the organic EL element 2, the light emitting section 20 is constituted by the region where only the organic EL layer 22 is interposed between the first electrode 21 and second electrode 23, and the plane shape of the light emitting section 20 is rectangular (square shape in the illustrated example), similarly to the shape of the inner rim of the insulating film 29. In the planar light emitting device A, a part other than the light emitting section 20 of the organic EL element 2 in the plan view defines a no-light-emitting section.

The cover substrate 5 is formed of a glass substrate, but the present embodiment is not limited to this. A plastic substrate may be used, for example. Examples of the glass substrate include a soda lime glass substrate and a non-alkali glass substrate. Examples of the plastic substrate include a polyethylene terephthalate (PET) substrate, a polyethylene naphthalate (PEN) substrate, a polyether sulfone (PES) substrate, and a polycarbonate (PC) substrate. When a plastic substrate is employed, an SiON film or an SiN film may be formed on a surface of the plastic substrate to suppress permeation of moisture. Preferably, the material of the cover substrate 5 has a small difference in coefficient of linear expansion between it and the material of the optically-transparent substrate 1. In order to reduce the stress that is caused by the difference in coefficient of linear expansion between the cover substrate 5 and the optically-transparent substrate 1, a material having no difference in coefficient of linear expansion is more preferable.

The cover substrate 5 is bonded to the element substrate 3 via the bonding section 4, as discussed above. Here, the interface between the bonding section 4 and the element substrate 3 includes: a first interface between the bonding section 4 and the first terminal T1; a second interface between the bonding section 4 and the second terminal T2; and a third interface between the bonding section 4 and the optically-transparent substrate 1.

The material of the bonding section 4 may be epoxy resin. However, the present embodiment is not limited to this. An acrylic resin or frit glass may be employed, for example. As the type of the epoxy resin or acrylic resin, an ultraviolet curable type or a thermosetting type may be employed. As the material of the bonding section 4, a material obtained by mixing a filler (e.g. silica or alumina) into epoxy resin may be employed.

The hygroscopic member 7 may be made of a drying agent of calcium oxide base (getter kneaded with calcium oxide), for example.

The material of the heat equalization plate 6 is, preferably, a metal of high thermal conductivity, of various metals, and copper is employed in the embodiment. The material of the heat equalization plate 6 is not limited to copper, and may be aluminum or gold, for example. As the heat equalization plate 6, metal foil (e.g. copper foil, aluminum foil, or gold foil) may be employed.

In the planar light emitting device A of the present embodiment, the opening size of the recess 51 in the cover substrate 5 is set larger than the size of the outer peripheral shape of the insulating film 29, and the periphery of the cover substrate 5 is bonded to the element substrate 3 via the bonding section 4. Thus, in the planar light emitting device A, the first electrode 21 and the second electrode 23 are not exposed to the outside, so that the humidity resistance can be improved. Of the organic EL element 2, only a part of each of the first terminal T1 and the second terminal T2 is exposed to the outside.

The first terminal T1 has a laminated structure of the first transparent conducting oxide layer 24 and the first metal layer 27, as discussed above. A region 24a for bonding constituted by only the first transparent conducting oxide layer 24 is disposed along the circumferential direction of the bonding section 4 over the whole length in the width direction of the first terminal T1. The second terminal T2 has a laminated structure of the second transparent conducting oxide layer 25 and the second metal layer 28, as discussed above. A region 25a for bonding constituted by only the second transparent conducting oxide layer 25 is disposed along the circumferential direction of the bonding section 4 over the whole length in the width direction of the second terminal T2. Therefore, the first interface between the bonding section 4 and the first terminal T1 is constituted by the interface between the bonding section 4 and the first transparent conducting oxide layer 24. The second interface between the bonding section 4 and the second terminal T2 is constituted by the interface between the bonding section 4 and the second transparent conducting oxide layer 25. In the planar light emitting device A of the present embodiment, thus, the bonding strength between the bonding section 4 and the first terminal T1 and the second terminal T2 can be improved. Furthermore, this configuration can prevent aging variation of the first interface and the second interface caused by aging and oxidation of the first metal layer 27 and second metal layer 28, and therefore can improve the reliability.

Since the planar light emitting device A of the present embodiment includes the heat equalization plate 6, the temperature of the light emitting section 20 of the organic EL element 2 can be equalized, in-surface variation in temperature of the light emitting section 20 can be reduced, and heat radiation property can be improved. In the planar light emitting device A, therefore, the temperature increase of the organic EL element 2 can be suppressed, and the lifetime can be extended when the input power is increased to increase the luminance.

In the planar light emitting device A of the present embodiment, the plane size of the light emitting section 20 is set at 80 mm□(80 mm×80 mm). However, the present embodiment is not limited to this. The plane size is appropriately set in a range of about 30 mm□ to 300 mm□(30 mm×30 mm to 300 mm×300 mm). The center-to-center distance between two first terminals T1 and T1 disposed on respective sides of the width direction of the second terminal T2 is set at 30 mm. However, this value is one example, and is not especially limited. The thickness of the first electrode 21 is set in a range of about 110 nm to 300 nm, the thickness of the organic EL layer 22 is set in a range of about 150 nm to 300 nm, the thickness of the second electrode 23 is set in a range of about 70 nm to 300 nm, the thickness of the insulating film 29 is set in a range of about 0.7 μm to 1 μm, and the thicknesses of the auxiliary electrode 26, the first metal layer 27, and the second metal layer 28 are set in a range of about 300 nm to 600 nm. These values are not especially limited.

The width of the auxiliary electrode 26 is preferably set in a range of about 0.3 mm to 3 mm. That is because, as the width increases, the impedance of the auxiliary electrode 26 decreases and the in-surface fluctuation in luminance of the light emitting section 20 decreases, but the area of the no-light-emitting section increases to decrease the light flux. In a luminaire where a plurality of planar light emitting devices A of the present embodiment are arranged and used as the light source, as the width of the auxiliary electrode 26 is decreased, the distance between adjacent light emitting sections 20 can be decreased and the appearance is enhanced. The distance between the rim of the optically-transparent substrate 1 and each of the first terminal T1 and the second terminal T2 is set at 0.2 mm, but is not especially limited to this value. Preferably, the distance is appropriately set in a range of about 0.1 mm to 2 mm. In order to reduce the area of the no-light-emitting sections of the planar light emitting devices A, preferably, the distance between the rim of the optically-transparent substrate 1 and each of the first terminal T1 and the second terminal T2 is decreased. Note that, when a predetermined creepage distance is required to be secured between other metal member (for example, a metallic body of a luminaire) and the first terminal T1 and the second terminal T2, it is preferable to set the distance to be longer than the creepage distance.

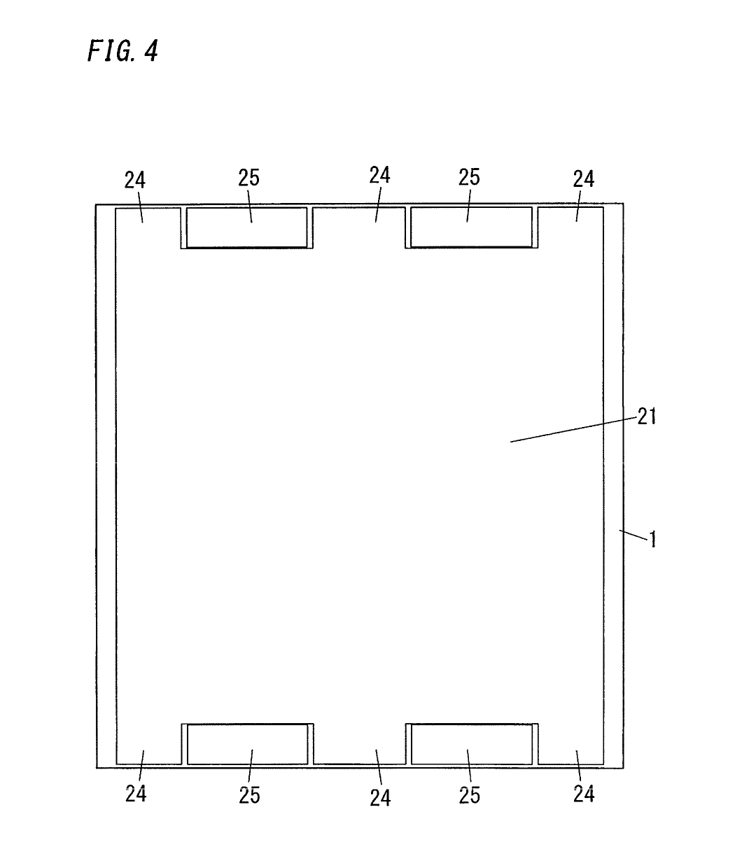

Hereinafter, a manufacturing method of the planar light emitting device A of the present embodiment is described with reference to FIG. 4 to FIG. 10.

First, the structure of FIG. 4 is obtained by simultaneously forming the first electrode 21, the first transparent conducting oxide layer 24, and the second transparent conducting oxide layer 25, which are made of the same transparent conducting oxide (for example, ITO, AZO, GZO, or IZO), on the one surface side of the optically-transparent substrate 1 formed of a glass substrate, through a vapor deposition method or a spattering method.

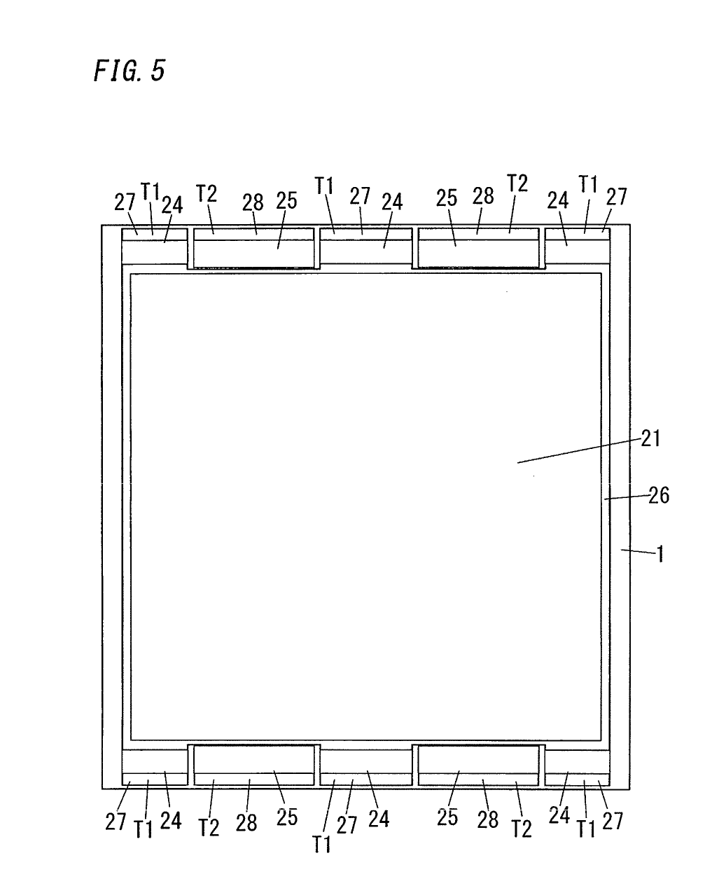

Next, the structure of FIG. 5 is obtained by simultaneously forming the auxiliary electrode 26, the first metal layer 27, and the second metal layer 28, which are made of the same metal material or the like, on the one surface side of the optically-transparent substrate 1, through a vapor deposition method or a spattering method.

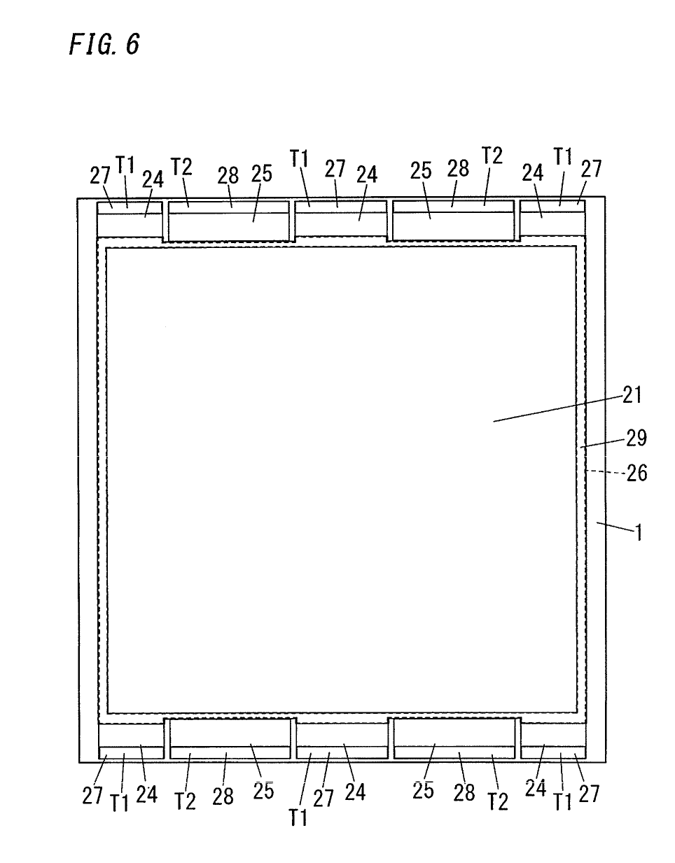

Then, the structure of FIG. 6 is obtained by forming the insulating film 29 made of a resin material (for example, polyimide, novolac resin, or epoxy resin) on the one surface side of the optically-transparent substrate 1.

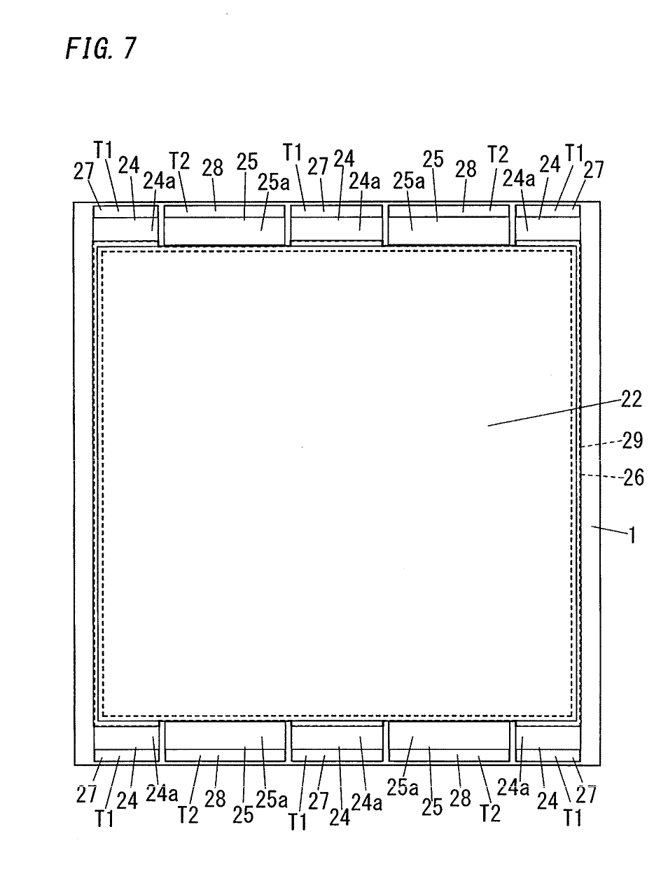

Then, the structure of FIG. 7 is obtained by forming the organic EL layer 22 on the one surface side of the optically-transparent substrate 1 through a vapor deposition method or the like. The forming method of the organic EL layer 22 is not limited to the vapor deposition method, and may be an application method. The forming method is appropriately selected in accordance with the material of the organic EL layer 22.

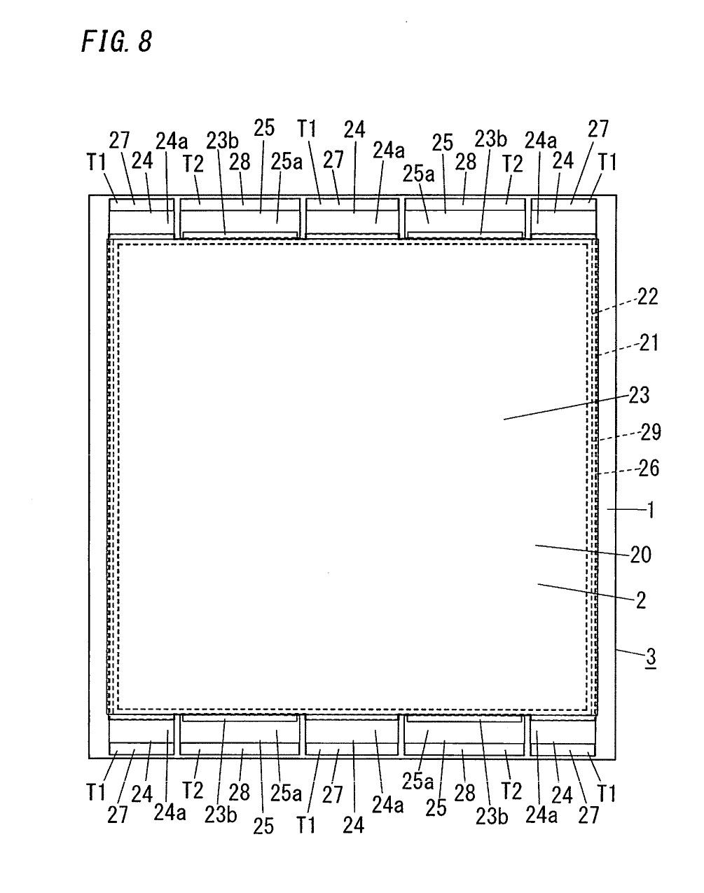

Then, the element substrate 3 having the structure of FIG. 8 is obtained by forming the second electrode 23 and the lead wire 23b, which are made of the same metal material (for example, aluminum or silver), on the one surface side of the optically-transparent substrate 1, through a vapor deposition method or a spattering method. The process up to here is an element substrate forming process of forming the organic EL element 2 on the one surface side of the optically-transparent substrate 1.

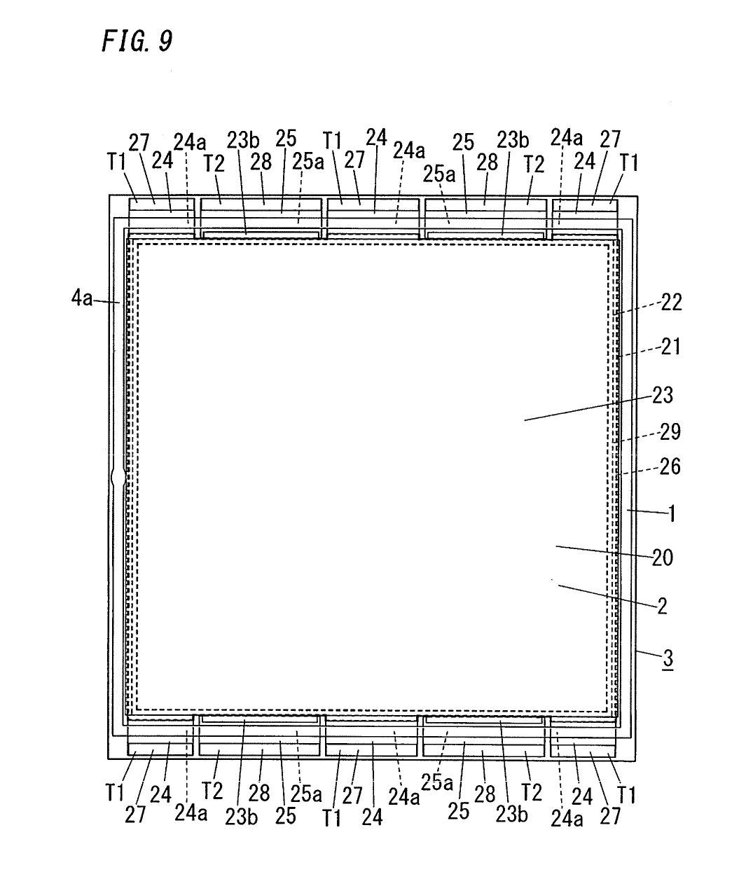

Then, the structure of FIG. 9 is obtained by applying an adhesive 4a (for example, epoxy resin, acrylic resin, or glass frit) as the material of the bonding section 4 to the element substrate 3 using a dispenser or the like. In the applying process of applying the adhesive 4a, the adhesive 4a is applied to the periphery of the element substrate 3 in a rectangular frame shape. However, the adhesive 4a may be applied to the periphery of the recess 51 of the cover substrate 5, instead of the element substrate 3, in a rectangular frame shape.

Then, an overlaying process is performed in which the cover substrate 5 on which the hygroscopic member 7 and the heat equalization plate 6 are previously pasted is overlaid on the element substrate 3. Then, a curing process of forming the bonding section 4 by curing the adhesive 4a is performed. Thus, the planar light emitting device A with the structure of FIG. 1 is obtained. In the overlaying process, the cover substrate 5 is overlaid and pressed on the element substrate 3, thereby pressing and spreading the adhesive 4a. In the curing process, ultraviolet rays are radiated to cure the adhesive 4a when the adhesive 4a is of an ultraviolet curable type, or the adhesive 4a is heated to cure the adhesive 4a when the adhesive 4a is of a thermal curable type. Note that, the pasting process of pasting the hygroscopic member 7 on the cover substrate 5, the applying process of applying the adhesive 4a to the element substrate 3 or the cover substrate 5, the overlaying process of overlaying the cover substrate 5 on the element substrate 3, and the curing process of curing the material of the bonding section 4 are performed in a nitrogen atmosphere whose dew point is −65° C., for example. The heat equalization plate 6 may be pasted on the cover substrate 5 after the adhesive 4a of the bonding section 4 is cured.

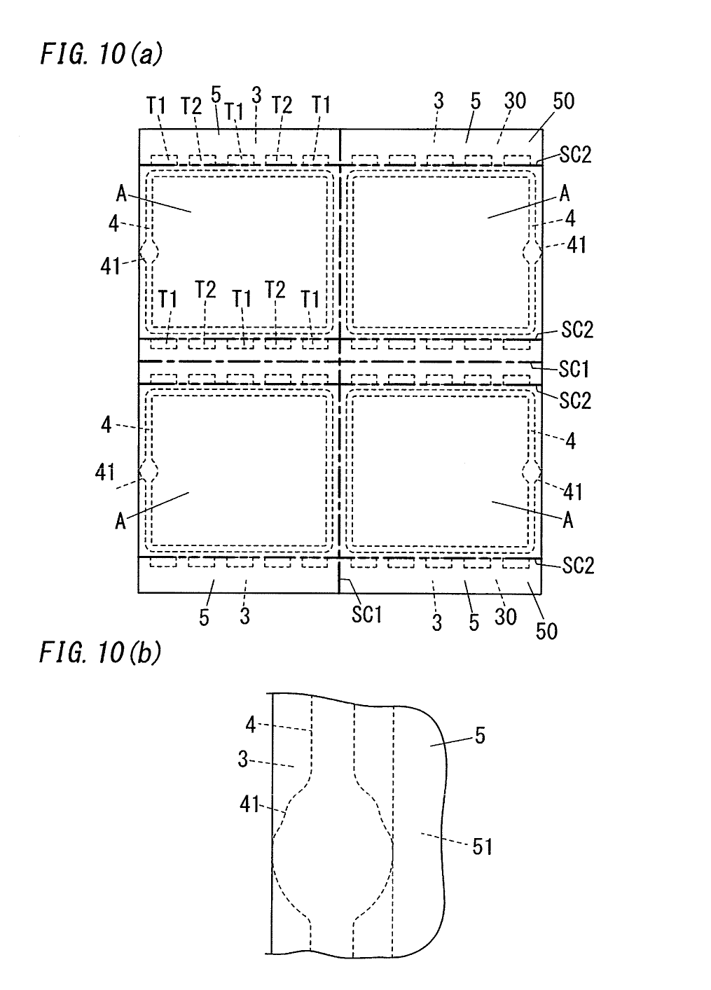

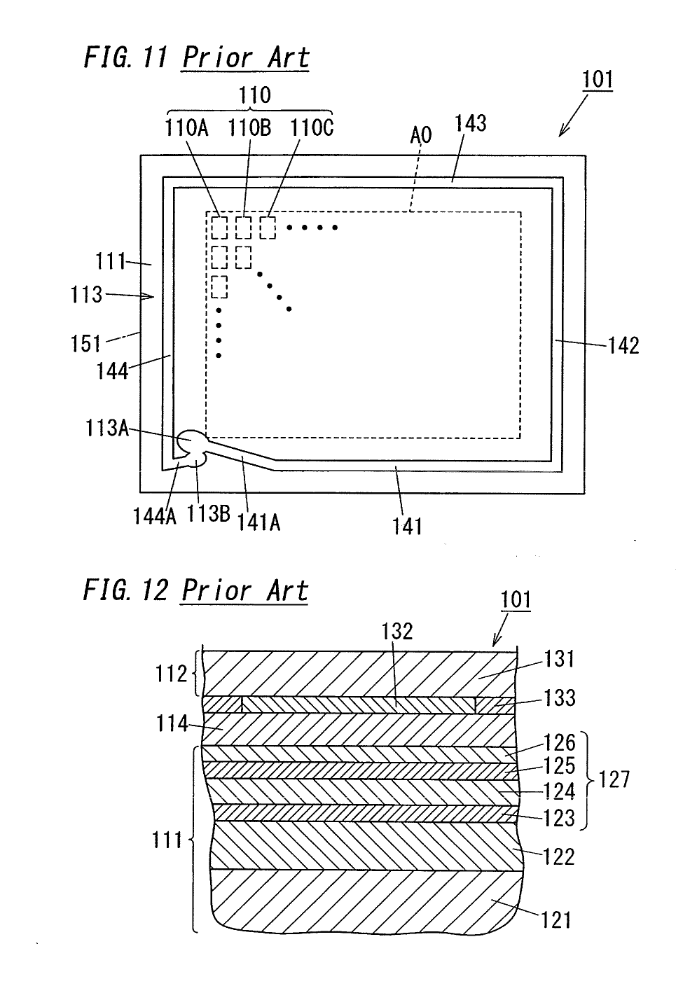

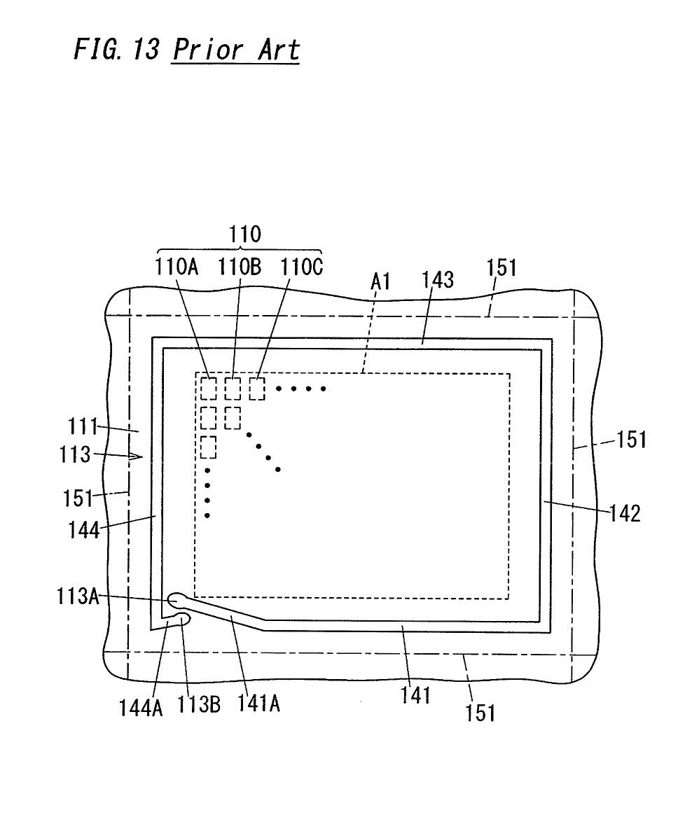

The manufacturing method of the planar light emitting device A is further described. The manufacturing method includes an applying process of applying the adhesive 4a to a first substrate 30 (see FIG. 10(a)) or to a second substrate 50 (see FIG. 10(a)). Here, the first substrate 30 has a rectangular plate shape allowing element substrates 3 to be arranged in a 2×2 array and can be divided into individual element substrates 3. The second substrate 50 has a rectangular plate shape allowing cover substrates 5 to be arranged in a 2×2 array and can be divided into individual cover substrates 5. In this case, the first substrate 30 may have any rectangular plate shape as long as the shape allows element substrates 3 to be arranged in a 2×i (“i” is an integer of 1 or more) array. The second substrate 50 may have any rectangular plate shape as long as the shape allows cover substrates 5 to be arranged in a 2×j (“j” is equal to “i”) array.

After the applying process, an overlaying process of overlaying the second substrate 50 on the first substrate 30 is performed, and subsequently a curing process of forming the bonding section 4 by curing the adhesive 4a is performed. Then, a dividing process is performed in which the first substrate 30 is divided into individual element substrates 3 and the second substrate 50 is divided into individual cover substrates 5 is performed.

In the applying process, a starting point of application and a finishing point of application when the adhesive 4a is applied in a rectangular frame shape using a dispenser, are set in a scheduled region for forming a wide section 41.

In dividing the first substrate 30 in the dividing process, scribe lines SC1 are drawn by a scriber in the surface of the first substrate 30 on the opposite side to the second substrate 50, and then the first substrate 30 is cut by applying pressure from the second substrate 50 side using a break machine, for example. In dividing the second substrate 50 in the dividing process, scribe lines SC2 are drawn by a scriber in the surface of the second substrate 50 on the opposite side to the first substrate 30, and then the second substrate 50 is cut by applying pressure from the first substrate 30 side using a break machine, for example. When it is assumed that FIG. 1 shows the upper left planar light emitting device A in FIG. 10(a), the right side surface of the optically-transparent substrate 1 of FIG. 1 corresponds to a cut surface 1a (see FIG. 3(c)), the lower side surface thereof corresponds to a cut surface 1a (see FIG. 2(c)), the left side surface thereof corresponds to a non-cut surface 1b (see FIG. 3(a) and FIG. 3(b)), and the upper side surface thereof corresponds to a non-cut surface 1b (see FIG. 2(a) and FIG. 2(b)). The right side surface of the cover substrate 5 of FIG. 1 corresponds to a cut surface 5a (see FIG. 3(c)), the lower side surface thereof corresponds to a cut surface 5a (see FIG. 2(c)), the left side surface thereof corresponds to a non-cut surface 5b (see FIG. 3(a) and FIG. 3(b)), and the upper side surface thereof corresponds to a cut surface 5a (see FIG. 2(a) and FIG. 2(b)). The cut surfaces 1a and 5a may be chamfered after cutting. The shape of the first substrate 30 is not limited to the rectangular plate shape that allows element substrates 3 to be arranged in a 2×i (“i” is an integer of 1 or more) array. The first substrate 30 may have a rectangular plate shape larger than the element substrate 3 having a previously defined first unit size, and may be divided into element substrates 3 having the first unit size or a desired outside size smaller than the first substrate 30. The shape of the second substrate 50 is not limited to the rectangular plate shape that allows cover substrates 5 to be arranged in a 2×j (“j” is equal to “i”) array, either. The second substrate 50 may have a rectangular plate shape larger than the cover substrates 5 having a previously defined second unit size, and may be divided into cover substrates 5 having the second unit size or a desired outside size smaller than the second substrate 50.

In the above-mentioned manufacturing method of the planar light emitting device A of the present embodiment, in the applying process, the starting point of application and the finishing point of application when the adhesive 4a is applied in a rectangular frame shape using a dispenser are set in a scheduled region for forming the wide section 41. Therefore, the application amount of the adhesive 4a can be increased at the starting point and the finishing point when the adhesive 4a is applied. The adhesive 4a therefore can be more accurately formed in a rectangular frame shape of a closed loop, and the reliability can be improved. In the manufacturing method of the planar light emitting device A of the present embodiment, the wide section 41 wider than the other portions is disposed on a portion along the non-cut surface 1b, which is not the cut surface 1a, of the four side surfaces of the optically-transparent substrate 1. Therefore, the area of the no-light-emitting section can be reduced. In the manufacturing method of the planar light emitting device A, the wide section 41 can be prevented from disturbing the dividing of the first substrate 30 and second substrate 50 in the dividing process. Therefore, the manufacturing yield can be improved and the cost can be reduced.

In the manufacturing method of the planar light emitting device A of the present embodiment, in the applying process, it is preferable that the adhesive 4a is applied to the periphery of the recess 51 of the cover substrate 5 of the second substrate 50 in a rectangular frame shape, not to the element substrate 3 of the first substrate 30. Thus, the spread of a part in the width direction of the adhesive 4a corresponding to the wide section 41 is regulated by the non-cut surface 1b and the recess 51 of the second substrate 50 (see FIG. 3(b) and FIG. 10(b)), so that the excessive increase in width of the wide section 41 of the bonding section 4 can be suppressed. In other words, in the manufacturing method of the planar light emitting device A of the present embodiment, the accuracy of the maximum width of the wide section 41 of the bonding section 4 can be determined based on the position accuracy of the recess 51. When a glass substrate is used as the second substrate 50, the recess 51 can be formed by a sandblast method, an etching method, or a press molding method.

The above-mentioned planar light emitting device A of the present embodiment includes the following elements: an element substrate 3 including an optically-transparent substrate 1 of a rectangular plate shape and an organic EL element 2 formed on one surface side of the optically-transparent substrate 1; a cover substrate 5 of a rectangular plate shape; and a bonding section 4 that is formed in a rectangular frame shape surrounding a light emitting section 20 of the organic EL element 2 on the one surface side of the optically-transparent substrate 1 and is made of an adhesive bonding the element substrate 3 to the cover substrate 5. The bonding section 4 has a wide section 41 wider than the other portions, in a portion along the non-cut surface 1b, which is not the cut surface 1a, of the four side surfaces of the optically-transparent substrate 1. In the planar light emitting device A of the present embodiment, therefore, the area of the no-light-emitting section can be reduced and the reliability can be improved.

For details, the planar light emitting device includes an element substrate, a cover substrate, and a bonding section. The element substrate includes an optically-transparent substrate and an organic EL element. The optically-transparent substrate is formed in a rectangular plate shape. The organic EL element is formed on one surface side of the optically-transparent substrate. The cover substrate is formed in a rectangular plate shape. The bonding section is formed on the one surface side of the optically-transparent substrate. The bonding section is formed in a rectangular frame shape so as to surround a light emitting section of the organic EL element. The bonding section has an adhesive. The adhesive bonds the element substrate and the cover substrate together.

The bonding section has a predetermined portion. The predetermined portion is defined by a portion along the non-cut surface of the optically-transparent substrate. The non-cut surface is defined as a surface other than the cut surface, of the four side surfaces of the optically-transparent substrate.

The predetermined portion of the bonding section has a wide section. The wide section is set wider than portions other than the predetermined portion.

Therefore, in the planar light emitting device A of the present embodiment, the area of the no-light-emitting section can be reduced and the reliability can be improved.

The cut surface of the planar light emitting device is defined as a surface formed when a plurality of planar light emitting devices are divided into individual planar light emitting devices.

The cut surface of the planar light emitting device is defined as a surface formed when the first substrate having a plurality of element substrates is divided into individual element substrates.

The cut surface of the planar light emitting device is defined as a surface formed when the first substrate having a plurality of element substrates arranged in a 2×i array shape is divided into individual element substrates.

In the planar light emitting device A of the present embodiment, the organic EL element 2 includes a first electrode 21, an organic EL layer 22, a second electrode 23, a first terminal T1, a second terminal T2, and an auxiliary electrode 26, as discussed above. The first terminal T1 and the second terminal T2 are disposed at each of both ends of a defined direction of the one surface of the optically-transparent substrate 1. Preferably, the wide section 41 of the bonding section 4 is formed at a position where the width direction corresponds to the direction orthogonal to the defined direction. Thus, in the planar light emitting device A of the present embodiment, the luminance can be increased and the in-surface uniformity of the luminance can be improved. Further, the area of no-light-emitting section can be reduced. In a luminaire where a plurality of planar light emitting devices A of the present embodiment are arranged in the direction orthogonal to the defined direction and are used as the light source, the distance between adjacent light emitting sections 20 can be decreased and the appearance is enhanced.

In the planar light emitting device A of the present embodiment, as discussed above, the first terminal T1 and the second terminal T2 preferably have a laminated structure of the transparent conducting oxide layers 24 and 25 and the metal layers 27 and 28, respectively, and only the transparent conducting oxide layers 24 and 25 are in contact with the bonding section 4. Thus, in the planar light emitting device A of the present embodiment, the luminance can be increased and the in-surface uniformity of the luminance can be improved, and the bonding strength between the bonding section 4 and the first terminal T1 and the second terminal T2 can be improved. Furthermore, it can be prevented that oxidation is caused by aging of the first metal layer 27 and the second metal layer 28 and the states of the first interface and the second interface vary, and the reliability can be improved. The planar light emitting device A of the present embodiment is compared with a comparative example where the metal layers 27 and 28 are in contact with the bonding section 4 in the first terminal T1 and second terminal T2. According to this comparison, in the planar light emitting device A of the present embodiment, the time required for the area (dark area) that does not emit light in the light emitting section 20 to move by a defined distance from an edge of the light emitting section 20 is longer than in the comparative example. Therefore, in the planar light emitting device A of the present embodiment, the lifetime can be extended, in addition to improve gas barrier property for blocking moisture and oxygen.

In the planar light emitting device A of the present embodiment, by setting the total dimension of widths of first terminals T1 and that of second terminals T2 to have the same value, the current made to flow through the organic EL element 2 can be increased and the luminous efficiency can be improved. In the planar light emitting device A of the present embodiment, when current of a critical current density (1×10⁵ A/cm² when the metal is aluminum) or more flows through the lead wire 23b for a long time, there is a possibility of causing disconnection due to occurring electro-migration. The first transparent conducting oxide layer 24 that is made of TOC such as ITO and is continuous to the first electrode 21 has a critical current density larger than that of the lead wire 23b and has a margin of the critical current density larger than that of the lead wire 23b. Therefore, in the planar light emitting device A of the present embodiment, the electro-migration resistance can be improved by making the total dimension of widths of second terminals T2 larger than that of first terminals T1. Here, in FIG. 1, the total dimension of widths of second terminals T2 means the total dimension of widths (vertical dimensions in FIG. 1) of the four second terminals T2, and the total dimension of widths of first terminals T1 means the total dimension of widths (vertical dimensions in FIG. 1) of the six first terminals T1.

In the planar light emitting device A of the present embodiment, m (m≧1) second terminals T2 and (m+1) first terminals T1 are disposed along each of two predetermined parallel sides of the light emitting section 20 of a rectangular shape in the plan view. Here, a first terminal T1 is positioned on each of the both sides of a second terminal T2 in the width direction. The first transparent conducting oxide layer 24 and the second transparent conducting oxide layer are set to have the same thicknesses. In the planar light emitting device A of the present embodiment, thus, the bonding strength and adhesiveness of the bonding section 4 to the first terminal T1 and to the second terminal T2 can be made uniform, and the reliability can be improved.

As for the plan-view shape of the optically-transparent substrate 1, a rectangular shape includes a square shape as well as an oblong shape. When the plan-view shape of the optically-transparent substrate 1 is a square shape, the plan-view shape of the light emitting section 20 is set as an oblong shape, and two short sides of the oblong light emitting section 20 are set as the two predetermined sides. The following setting may be employed: the plan-view shape of the optically-transparent substrate 1 is set as an oblong shape, the plan-view shape of the light emitting section 20 is set as an oblong shape that is non-similar to that of the optically-transparent substrate 1, and two long sides of the rectangular light emitting section 20 are set as the two predetermined sides.

In the organic EL element 2, the first electrode 21 formed of a transparent electrically conductive film works as an anode, and the second electrode 23 of a sheet resistance lower than that of the first electrode 21 works as a cathode. However, the first electrode 21 may work as a cathode, and the second electrode 23 may work as an anode. Either case may be employed as long as light can be extracted through the first electrode 21 formed of a transparent electrically conductive film.

The manufacturing method of the planar light emitting device includes an applying process, an overlaying process, a curing process, and a dividing process. In the applying process, an adhesive is applied to a first substrate to be divided into individual element substrates. The first substrate has a rectangular plate shape allowing the element substrates to be arranged in a 2×i array. Here, “i” is an integer of 1 or more. In the overlaying process, a second substrate and the first substrate are overlaid together. In the curing process, a bonding section is formed by curing the adhesive. In the dividing process, the first substrate is divided into individual element substrates. In the dividing process, the second substrate is divided into individual cover substrates.

In the applying process, a starting point of application and a finishing point of the application when the adhesive is applied in the rectangular frame shape by a dispenser are set in a scheduled region for forming a wide section.

In the applying process in the manufacturing method of the planar light emitting device, an adhesive is applied to the first substrate to be divided into individual element substrates. However, the object to which the adhesive is applied is not limited to the first substrate. In other words, in the manufacturing method of the planar light emitting device, the applying process can be changed.

The manufacturing method of the planar light emitting device includes an applying process, an overlaying process, a curing process, and a dividing process. In the applying process, an adhesive is applied to a second substrate to be divided into individual cover substrates. The second substrate has a rectangular plate shape allowing the cover substrates to be arranged in a 2×j array. Here, “j” equals to “i”, and “j” is an integer of 1 or more. In the overlaying process, a second substrate and the first substrate are overlaid together. In the curing process, a bonding section is formed by curing the adhesive. In the dividing process, the first substrate is divided into individual element substrates. In the dividing process, the second substrate is divided into individual cover substrates.

In the applying process, a starting point of application and a finishing point of the application when the adhesive is applied in the rectangular frame shape by the dispenser are set in a scheduled region for forming the wide section.

In the applying process, the starting point of application and the finishing point of application are formed so as to be connected.

The planar light emitting device A of the present embodiment can be suitably employed as the light source for illumination, but can be used for another application other than illumination.

### REFERENCE SIGNS LIST

A Planar light emitting device
1 Optically-transparent substrate
1a Cut surface
1b Non-cut surface
2 Organic EL element
3 Element substrate
4 Bonding section
4a Adhesive
5 Cover substrate
20 Light emitting section
21 First electrode
22 Organic EL layer
23 Second electrode
24 Transparent conducting oxide layer
25 Transparent conducting oxide layer
26 Auxiliary electrode
27 Metal layer
28 Metal layer
T1 First terminal
T2 Second terminal
41 Wide section
30 First substrate
50 Second substrate

1. A planar light emitting device comprising:
an element substrate including an optically-transparent substrate of a rectangular plate shape and an organic EL element formed on one surface side of the optically-transparent substrate;
a cover substrate of a rectangular plate shape; and
a bonding section that is made of an adhesive and is formed in a rectangular frame shape surrounding a light emitting section of the organic EL element on the one surface side of the optically-transparent substrate to bond the element substrate and the cover substrate together,
wherein the bonding section has a wide section in a portion along a non-cut surface among four side surfaces of the optically-transparent substrate, the non-cut surface being not a cut surface, the wide section being wider than other portions of the bonding section.

2. The planar light emitting device according to claim 1, wherein
the organic EL element comprises:
a first electrode disposed on the one surface side of the optically-transparent substrate, the first electrode being formed of a transparent electrically conductive film;
an organic EL layer disposed on a surface of the first electrode on an opposite side to the optically-transparent substrate, the organic EL layer including at least a light emitting layer;
a second electrode disposed on a surface of the organic EL layer on an opposite side to the first electrode, the second electrode being formed of a metal film;
a first terminal electrically connected to the first electrode;
a second terminal electrically connected to the second electrode; and
an auxiliary electrode made of a material of a specific resistance lower than that of the first electrode, the auxiliary electrode being formed along a periphery of a surface of the first electrode on an opposite side to the optically-transparent substrate, the auxiliary electrode being electrically connected to the first electrode,
in the element substrate, the first terminal and the second terminal are disposed at each of both ends of a defined direction on the one surface of the optically-transparent substrate, and
the wide section is formed at a position where a direction orthogonal to the defined direction corresponds to a width direction of the wide section.

3. The planar light emitting device according to claim 1, wherein
each of the first terminal and second terminal has a laminated structure of a transparent conducting oxide layer and a metal layer, and only the transparent conducting oxide layer is in contact with the bonding section.

4. A manufacturing method of the planar light emitting device according to claim 1, the manufacturing method comprising:
an applying step of applying the adhesive to a first substrate or a second substrate, the first substrate having a rectangular plate shape allowing the element substrates to be arranged in a 2×i (i is an integer of 1 or more) array and being to be divided into the individual element substrates, the second substrate having a rectangular plate shape allowing the cover substrates to be arranged in a 2×j (j is equal to i) array and being to be divided into the individual cover substrates;
an overlaying step of overlaying the second substrate and the first substrate together;
a curing step of forming the bonding section by curing the adhesive; and
a dividing step of dividing the first substrate into the individual element substrates and dividing the second substrate into the individual cover substrates,
wherein, in the applying step, a starting point of application and a finishing point of application when the adhesive is applied in the rectangular frame shape by a dispenser are set in a scheduled region for forming the wide section.

5. The planar light emitting device according to claim 2, wherein
each of the first terminal and second terminal has a laminated structure of a transparent conducting oxide layer and a metal layer, and only the transparent conducting oxide layer is in contact with the bonding section.

6. A manufacturing method of the planar light emitting device according to claim 2, the manufacturing method comprising:
an applying step of applying the adhesive to a first substrate or a second substrate, the first substrate having a rectangular plate shape allowing the element substrates to be arranged in a 2×i (i is an integer of 1 or more) array and being to be divided into the individual element substrates, the second substrate having a rectangular plate shape allowing the cover substrates to be arranged in a 2×j (j is equal to i) array and being to be divided into the individual cover substrates;
an overlaying step of overlaying the second substrate and the first substrate together;
a curing step of forming the bonding section by curing the adhesive; and
a dividing step of dividing the first substrate into the individual element substrates and dividing the second substrate into the individual cover substrates,
wherein, in the applying step, a starting point of application and a finishing point of application when the adhesive is applied in the rectangular frame shape by a dispenser are set in a scheduled region for forming the wide section.

7. A manufacturing method of the planar light emitting device according to claim 3, the manufacturing method comprising:
an applying step of applying the adhesive to a first substrate or a second substrate, the first substrate having a rectangular plate shape allowing the element substrates to be arranged in a 2×i (i is an integer of 1 or more) array and being to be divided into the individual element substrates, the second substrate having a rectangular plate shape allowing the cover substrates to be arranged in a 2×j (j is equal to i) array and being to be divided into the individual cover substrates;
an overlaying step of overlaying the second substrate and the first substrate together;
a curing step of forming the bonding section by curing the adhesive; and
a dividing step of dividing the first substrate into the individual element substrates and dividing the second substrate into the individual cover substrates,
wherein, in the applying step, a starting point of application and a finishing point of application when the adhesive is applied in the rectangular frame shape by a dispenser are set in a scheduled region for forming the wide section.

8. A manufacturing method of the planar light emitting device according to claim 5, the manufacturing method comprising:
an applying step of applying the adhesive to a first substrate or a second substrate, the first substrate having a rectangular plate shape allowing the element substrates to be arranged in a 2×i (i is an integer of 1 or more) array and being to be divided into the individual element substrates, the second substrate having a rectangular plate shape allowing the cover substrates to be arranged in a 2×j (j is equal to i) array and being to be divided into the individual cover substrates;
an overlaying step of overlaying the second substrate and the first substrate together;
a curing step of forming the bonding section by curing the adhesive; and
a dividing step of dividing the first substrate into the individual element substrates and dividing the second substrate into the individual cover substrates, wherein, in the applying step, a starting point of application and a finishing point of application when the adhesive is applied in the rectangular frame shape by a dispenser are set in a scheduled region for forming the wide section.
